(19) United States
(12) Patent Application Publication
(10) Pub. No.: US 2015/0053090 A1
(43) Pub. Date: Feb. 26, 2015

(54) PORTABLE CUP LID ASSEMBLY WITH A D-SHAPED INFUSER BASKET OR STRAINER

(71) Applicant: William Harold Berger, Arcadia, CA (US)

(72) Inventor: William Harold Berger, Arcadia, CA (US)

(21) Appl. No.: 14/290,925

(22) Filed: May 29, 2014

Related U.S. Application Data
(60) Provisional application No. 61/870,077, filed on Aug. 26, 2013.

(51) Int. Cl. A47J 31/06

(52) U.S. Cl. CPC A47J 31/0636
USPC 99/295; 99/322

(57) ABSTRACT

A portable cup lid for container or glass or cup or vessel beverages like tea, soups, herbal drinks etc from a container or cup or glass or vessels. The cup lid is designed into a single integrated piece comprising annular cover with D-shaped infuser basket and an ingesting receptacle reversibly attached to a disposable or a non-disposable container or glass or cup or vessel. The D-shaped infuser basket is for utilizing infusible bags or loose infusible materials. Where, D shaped infuser restricts fluid from contact with the infusible material in a tilted position Therefore, the particular assembly makes consuming of infusible, fluids hassle free, safe, disposable, portable and palatable.

### CROSS REFERENCE TO RELATED APPLICATIONS

This application claims priority of U.S. Provisional Application No. 61/870077, titled ‘TEA BAG LID WITH INCORPORATED STRAINER, filed on Aug. 26, 2013, which is incorporated by reference herein in its entirety and for all purposes.

### FIELD OF THE INVENTION

A portable cup lid assembly with a D-shaped infuser basket integrated into one piece. More particularly, the present invention further relates to a cup lid where an infusible bag or brewing material is not require to be removed during drinking or sipping and also positioning of the D-shaped infuser basket into cup lid design which prevents over brewing and maintains desired flavor.

### BACKGROUND OF THE INVENTION

Drinking tea or any other product that requires brewing or infusion is a matter of taste i.e. every customer has a unique requirement of palatability. Therefore, there are no standards of brewing. Some customers may prefer a light brew and others very strong brew that may even be considered bitter. That is why vendors provide customers means to conduct their own brewing to suit their requirements.

The following prior arts are related to methods and device that are provided by the vendors to facilitate selective brewing; classified under two major categories.

### Restricting Infusion by Removing the Infusion Bag

As shown in U.S. Pat. No. 5,657,898. It describes a container cover having chamber for retaining a porous filter hag, such as a tea bag. The cover has an upwardly extending protrusion forming the retaining chamber. The protrusion has an aperture enabling passage of the drawstring of the tea hag. An opening closed by a removable lift tab is formed in the container cover for access to liquid contents of the container. The protrusion and opening are located opposite one another on the container cover. The user withdraws the tea bag from the liquid contents of the container into the retaining chamber by pulling the drawstring of the tea bag through the aperture. The aperture resiliently grasps the drawstring. The container cover and porous filter bag are used and discarded without causing direct handling of the porous filter bag. Other similar prior art include U.S. Pat. No. 3,861,284.

### Basket Based Systems for Restricting Infusion

U.S. Pat. No. 8,205,542 B2 describes an integrated beverage infuser and lid are adapted for use with an insulated container or glass or cup or vessel for brewing a consumable product, such as tea, in an insulated travel mug, tumbler, or the like. A fluid-permeable brewing basket defines an enclosable receptacle for removable receipt of the brewing consumable product. The basket is movable between a stowed position, substantially within the cavity above the liquid level of the hot water in the tumbler, and a deployed position, below and substantially outside of the cavity for submersion in the hot water contained in the container or glass or cup or vessel. A lever arm forms a part of the transfer mechanism and has a portion that penetrates the main body to the outside thereof so that the transfer mechanism can be operated by an individual without removing the lid from the insulated container or glass or cup or vessel, tumbler, or the like.

Patent application number WO2013162438 A1, discusses the prior art that provides an invention where the transition of the lid from an active to a non-active brewing position takes place in an extremely user-friendly manner with the help. of the laminar closing member.

In U.S. Pat. No. 6,202,542 the well portion of the infuser unit (basket) preferably extends down far enough so that the tea leaves in the bottom of the well will be below a level of liquid in the container. In this manner, the tea will continue to seep or brew as the water level in the beverage container is above the level of the tea leaves in the bottom of the well. Other similar prior art includes JP2006198356A2

### DRAWBACKS IN PRIOR ART

### Restricting Infusion by Removing the Infusion Bag

The related prior arts propose the fact that for attaining a selective brew, the infusible bag has to be manually pulled from a constricted channel. This poses some major risks like breaking of the string that is attaching the tea bag and releasing the infusion bag into the vessel that may make tea bitter and also adds a hassle of removing it. Furthermore, the connecting clip that holds the infusion bag and the string, is not designed to withstand strain of pulling though a constricted channel therefore this could lead to dislodging of the pin and choking a potential consumer. Lastly, the constricting channel also squeezes the bag that can lead to bursting of the bag; and if string less bags are used then there are sanitary issues of handling the bag and the whole system of removing the tea bag by pulling becomes redundant.

### Basket Based Systems for Restricting Infusion

The related prior art proposes a lever based system that moves the basket away from water thus restricting infusion. Yet another related prior art provides a laminar basket system with a laminar sheath or a protective layer that keeps the basket in the stowed position.

The problem with such mechanisms is that they are not suitable for disposable cups as they are too expensive to manufacture. Moreover, the biggest drawback of such systems is the shape and location of the basket. Both the prior arts that are referred from above have a centrally located circular basket. These baskets work efficiently when the assembly is kept in a horizontal position. The problem arises when such assembly is tilted for consumption. The centrally located circular baskets even when retracted from water with the help of a lever or when protected by a laminar sheath at the base of the basket still conies in contact with the fluid when the container or glass or cup or vessel is tilted for ingestion.

Therefore, these prior arts fail to limit brewing when the assembly is tilted for brewing even when the fluid level is half the total length of container or glass or cup or vessel. Therefore, unknowingly the infusible material is brewed for a significantly longer duration than intended thus making it non palatable and bitter.

THEREFORE, it is the primary object of the invention is to provide a fully integrated annular Cup lid with a D-shaped infuser basket reversibly attached to a disposable or a non disposable container or glass or cup or vessel forming an assembly.

### SUMMARY OF THE INVENTION

The present invention provides a portable cup lid, comprising of: an annular cover may be engaged with container or glass or cup or vessel; an ingesting receptacle with a conduit for drinking or sipping; and an infuser basket disposed within the said annular cover; wherein: the said infuser basket, is D-shaped, placed to the far end of the ingesting receptacle and away from the centre, that restricts the fluid contact when the container or glass or cup or vessel is tilted up to a maximum of 50 degrees towards the ingestion receptacle, with the fluid level in the container or glass or cup or vessel around the distal surface of the infuser basket; further the said D-shaped infuser extends downwardly to the fluid surface to immerse the infusible materials and facilitate infusion.

One aspect of the present invention, provides the cup lid with a D-shaped infuser basket and an ingesting receptacle, reversibly attached to a disposable or a non disposable container or glass or cup or vessel forming an assembly for drinking tea, soups, herbal drinks, coffee, cocoa etc. The D-shaped infuser basket facilitates infusing of the bagged or loose infusing materials. Furthermore, the D-shaped infuser basket is solid and evenly perforated for facilitating infusion.

In another aspect of the present invention, the D-shaped infuser basket used in a cup lid comprises of at least one hole, on the lateral walls extending downwardly, provided to avoid overflowing or spilling of the fluid on to the lid while pouring the fluid directly in the basket with or without the infusible bag or material.

In another aspect of the present invention, the D-shaped infuser basket in the cup lid is designed and placed so that the infusible bag or material is not required to remove during drinking or sipping. A lockable air tight cover with live hinge lift tab attached to the D-shaped infuser basket to prevent spilling the infusion material and fluid.

### BRIEF DESCRIPTION OF DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a perspective view of an integrated cup lid assembly with D-shaped infuser basket and an ingesting receptacle, reversibly attached to a disposable or a non disposable container or glass or cup or vessel forming an assembly.

FIG. 2A, FIG. 2B and FIG. 2C is top view, side view and front view of the portable Cup Lid, in which various embodiment of the present invention may be practiced.

FIG. 3 is a perspective view of the portable cup lid with D-shaped infuser basket, in Which various embodiment of the present invention may be practiced.

FIG. 4 is a perspective view of cup lid assembly with container or cup or glass or vessel, in which D-shaped infuser basket in cup lid restricts over infusion when the assembly is tilled for ingestion.

FIG. 5A is a back view of the Cup lid with D-shaped infuser basket; and FIG. 5B and FIG. 5C are perspective front views of the cup lid with D shaped infuser basket.

### DETAIL DESCRIPTION OF THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated or distorted and not drawn on scale for illustrative purposes. Where an indefinite or definite article is used when referring to a singular noun e.g. “a” or “an”, “the”, this includes a plural of that noun unless something else is specifically stated.

The present invention now will be described more fully hereinafter with reference to the accompanying drawings, in which some, but not all embodiments of the inventions are shown. While the following description details the preferred embodiments of the present invention is not limited in its application to the details of construction and arrangement of the parts illustrated in the accompanying drawings.

With reference to the figures, numerical designation has been given for each element to facilitate the reader's understanding of the present invention, and particularly with reference to the embodiments of the present invention illustrated in the figures; various preferred embodiments of the present invention are set forth below. The enclosed description and drawings are merely illustrative of preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

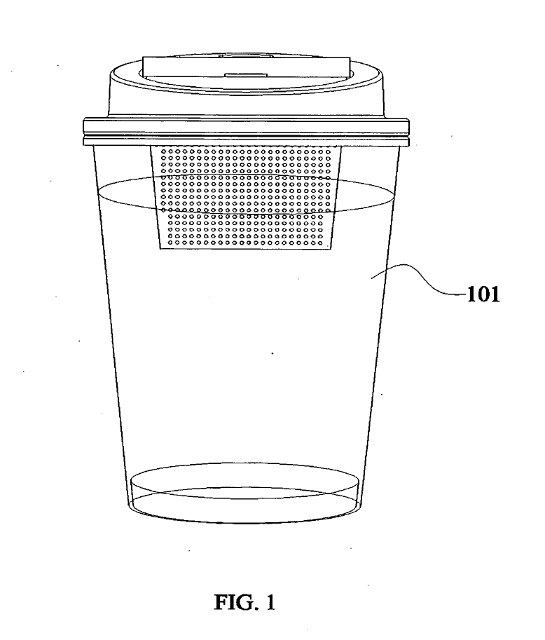

Referring now to the drawings in details, FIG. 1 shows an integrated cup lid assembly (101) with D-shaped infuser basket and an ingesting receptacle, reversibly attached to a disposable or a non disposable container or glass or cup or vessel forming an assembly. The preferred material for Cup lid with D-shaped infuser basket is a resilient material including but not limited to plastic that can be molded. The container or glass or cup or vessel may be made from materials including but not limited to thermoplastic or non thermoplastic or metal or paper. The ingesting receptacle with a conduit that allows for drinking or sipping. The container or glass or cup or vessel have preferably rounded side wall for better attachment. The D-shaped infuser basket is located distally to the container or glass or cup or vessel aperture, away from centre. The assembly allows infusion of the inserted bagged or loose infusible material. The assembly further allows the infusion process to be hassle free and safe. The assembly restricts the fluid contact with D-shaped infuser basket when the vessel is tilted up to a maximum of 50 degrees towards the ingestion receptacle with the fluid around distal surface of the infuser basket. The assembly further, restricts the fluid contact with D-shaped infuser basket when the vessel is tilted up to a maximum of 90 degrees towards the ingestion receptacle when the fluid level is half the container or glass or cup or vessel maximum length.

A portable cup lid, comprising of: an annular cover may be engaged with container or glass or cup or vessel; an ingesting receptacle with a conduit for drinking or sipping; and a infuser basket disposed within the said annular cover; wherein: the said infuser basket, is D-shaped, placed to the far end of the ingesting receptacle and away from the centre, that restricts the fluid contact when the container or glass or cup or vessel is tilted up to a maximum of 50 degrees towards the ingestion receptacle, with the fluid level in the container or glass or cup or vessel around the distal surface of the infuser basket; the said D shaped infuser extends downwardly to the fluid surface to immerse the infusible materials and facilitate infusion.

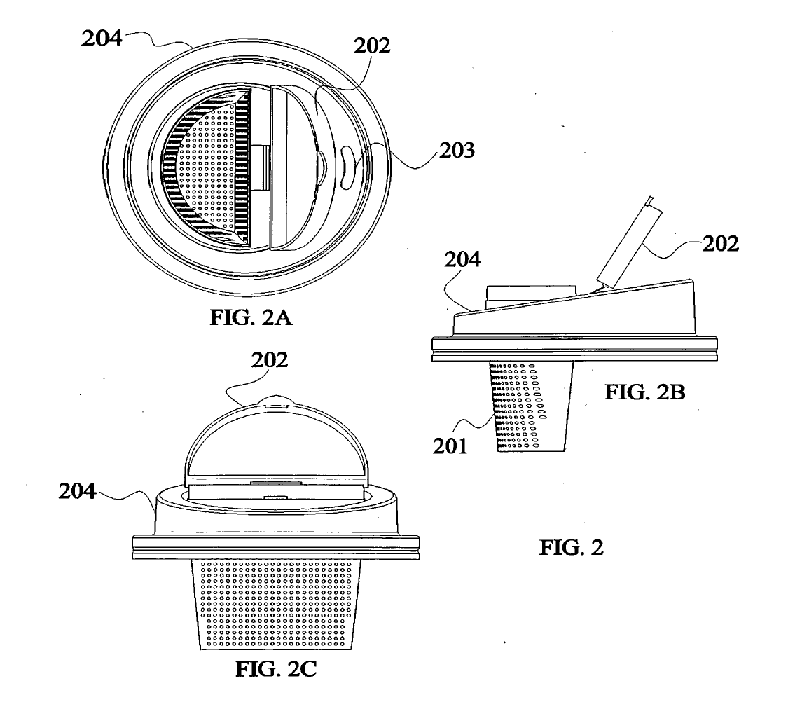

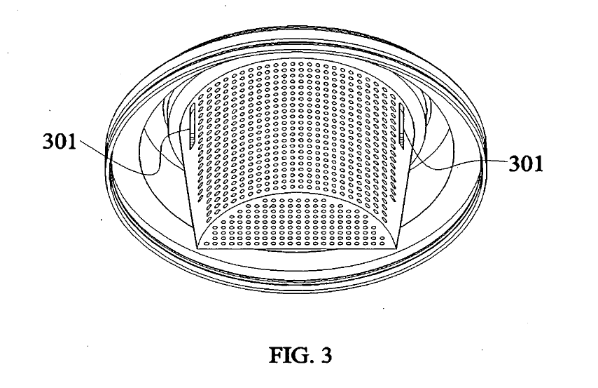

FIG. 2A shows the D-shaped infuser basket with uniform perforations on the lower end and a lockable air tight cover with live hinge lift tab (202) covering the D-shaped infuser basket (201) at the upper end. It also shows the portable cup lid having an ingesting receptacle (203) with a conduit for drinking or sipping and the annular cover (204). FIG. 2B shows the open lockable air tight cover with live hinge lift tab (202) covering the D-shaped infuser basket (201) which allows the insertion and storage of the infusible material and the annular cover (204). FIG. 2C shows the open lockable air tight cover with live hinge lift tab (202) covering the D-shaped infuser basket with uniform perforations on surface and the annular cover (204). FIG. 3 shows the D-shaped infuser basket has at least one overflowing holes (301) located near the annular cover (204) and uniform perforations on the surfaces.

In an embodiment of the present invention the D-shaped infuser basket is allowed for introduction of loose or bagged infusible material, wherein the infusible material further comprise of tea, soups, herbal drinks, coffee, cocoa etc. The D-shaped infuser is a strainer used for brewing of the infusible material.

In a preferred embodiment of the present invention, the cup lid is adapted for a reversible association with a container or glass or cup or vessel, wherein the cup lid is made of resistant thermo plastic or non plastic materials. The cup lid is disposable or non-disposable depending on use or material used in the lid.

In an another embodiment of the present invention, a portable cup lid, comprising of: an annular cover may be engaged with container or glass or cup or vessel; an ingesting receptacle with a conduit for drinking or sipping; and a infuser basket disposed within the said annular cover; wherein: the said infuser basket, is D-shaped, placed to the far end of the ingesting receptacle and away from the centre, that restricts the fluid contact when the container or glass or cup or vessel is tilted up to a maximum of 90 degrees towards the ingestion receptacle, with the fluid level in the container or glass or cup or vessel around half the maximum length; and the said D shaped infuser extends downwardly to the fluid surface to immerse the infusible materials and facilitate infusion.

In a use, the portable cup lid annular Cup lid with D-shaped infuser basket allows the fluid to be poured over the infusible material or attach the lid with the infusible material on top of the fluid filled container or glass or cup or vessel. In case the fluid is poured on the infusible material, the material may swell and block the perforations on the D-shaped infuser basket. Therefore, perforated sidewalls with at least one hole is provided to allow the fluid to be drained quickly into the container or glass or cup or vessel and stop the liquid from a potential backflow. In case a user wants to travel while brewing a lockable air tight cover with live hinge lift tab covering the D-shaped infuser basket prevents from spilling.

The perforations from surface of the D-shaped infuser basket allows the infusible material to seep, once a selective brew is obtained and maintain the flavor of the infused fluid further infusion is restricted even when the assembly is tilted for ingestion. Therefore, a user is not required to remove infusible material from the lid during ingesting.

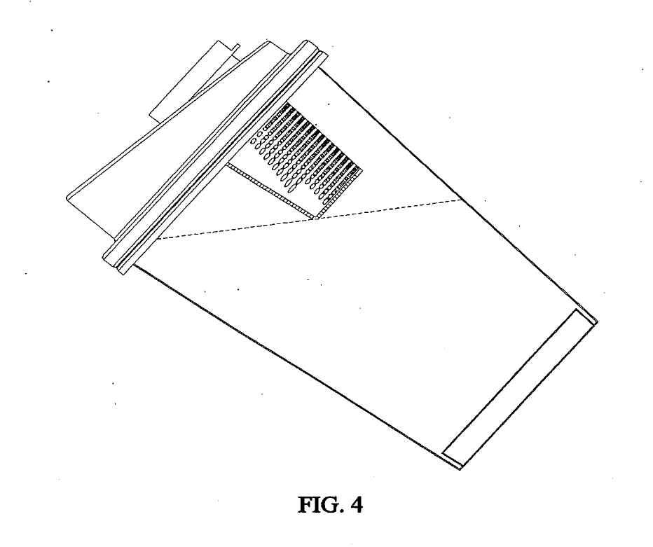

FIG. 4 further illustrates the cup lid assembly with container or cup or glass or vessel. Where D-shaped infuser basket in cup lid restricts over infusion when the assembly is tilted for ingestion. The restriction commences after a user has achieved desired flavor from the infusible materials. The D-shaped infuser basket allows the assembly to be tilted to a maximum of 50 degrees towards the ingestion receptacle with the fluid level just below the surface of the infuser basket. The length of the D-shaped infuser basket and the placement provides restriction. Further the assembly can be tilted up to a maximum of 90 degrees towards the ingestion receptacle when the fluid level is nearly half the length of the container or glass or cup or vessel.

In an exemplary embodiment of the present invention, the D-shaped infuser basket (length of 46 mm) is placed to the far end of the ingesting receptacle and away from the centre, the fluid contact is restricted when the vessel is tilted up to a maximum of 50 degrees towards the ingestion receptacle with the fluid level just below the surface of the infuser basket with the container or glass or cup or vessel's maximum holding capacity of eight US fluid ounces or 240 mL with the length of the container or glass or cup or vessel as 110 mm.

In another exemplary embodiment of the present invention, the D-shaped infuser basket (length of 46 mm) is placed to the far end of the ingesting receptacle and away from the centre, the fluid contact is restricted when the vessel is tilted up to a maximum of 90 degrees towards the ingestion receptacle when the fluid level is half the container or glass or cup or vessel part's maximum holding capacity eight US fluid ounces 240 mL with the length of the container or glass or cup or vessel as 110 mm.

An integrated cup lid assembly, comprising of an annular cover engaged with container or glass or cup or vessel; an ingesting receptacle with a conduit for drinking or sipping; an infuser basket also called as strainer is disposed within the said annular cover; and a container or glass or cup or vessel acting as a fluid reservoir. wherein infuser basket is D-shaped having uniform perforations on the surfaces, lockable air tight cover with live hinge lift tab of D-shape and at least one overflowing holes at upper end.

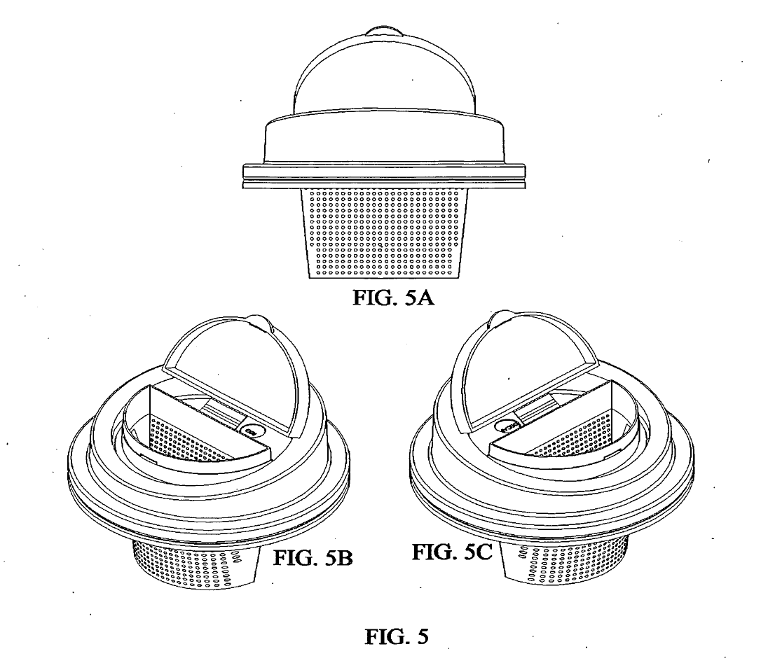

FIG. 5A shows the D-shaped infuser basket having uniform perforations on the back surface. It has a wider upper end and a narrower lower end (half frustum shape) which allows perfect stacking of the lids when the lockable air tight cover with live hinge lift tab is not engaged. FIG. 5B and FIG. 5C are perspective front views of the cup lid with D shaped infuser basket presented from two different angles. The D-shaped infuser basket can accommodate adequate infusible material required for one cup of drink.

In an advantage of portable cup lid of the present invention is to infuse several infusible materials such as tea, soups, herbal drinks, coffee, cocoa etc and the cup lid can be fitted into different shape container or cup or glass or vessel. The cup lid can be used for disposable lid.

In another advantage of the portable cup lid the present invention, the D-shaped infuser basket used in a cup lid comprises of at least one hole, on the lateral walls extending downwardly, provided to avoid overflowing or spilling of the fluid on to the lid while pouring the fluid directly in the basket with or without the infusible bag or material.

In another advantage of the portable cup lid the present invention, the D-shaped infuser basket in the cup lid is designed and placed so that the infusible bag or material is not required to be remove during drinking or sipping. A lockable air tight cover with live hinge lift tab attached to the D-shaped infuser basket to prevent spilling the infusion material and fluid.

One skilled in the art will appreciate that the embodiments provided above are exemplary and in no way limit the present invention.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The Abstract of the disclosure will allow the reader to quickly ascertain the nature of the technical disclosure. It is submitted with the understanding that it will not be used to interpret or limit the scope or meaning of the following claims.

I/We claim:

1. A portable cup lid, comprising of:
an annular cover may be engaged with container or glass or cup or vessel;
an ingesting receptacle with a conduit for drinking or sipping; and
a infuser basket disposed within the said annular cover;
wherein: the said infuser basket, is D-shaped, placed to the far end of the ingesting receptacle and away from the centre, that restricts the fluid contact when the container or glass or cup or vessel is tilted up to a maximum of 50 degrees towards the ingestion receptacle, with the fluid level in the container or glass or cup or vessel around the distal surface of the infuser basket; and the said D shaped infuser extends downwardly to the fluid surface to immerse the infusible materials and facilitate infusion.

2. The portable cup lid of claim 1, further comprising of lockable air tight cover with live hinge lift tab covering the D-shaped infuser basket.

3. The portable cup lid of claim 2, said cover is of D-shape.

4. The portable cup lid of claim 1, wherein the D-shaped infuser basket has at least one overflowing holes located near the annular cover.

5. The portable cup lid of claim 1, wherein D-shaped infuser basket having uniform perforations on the surfaces.

6. The portable cup lid of claim 1, wherein D-shaped infuser basket is allowed for introduction of loose or bagged infusible material.

7. The portable cup lid of claim 6, wherein the infusible material further comprise of tea, soups, herbal drinks, coffee, cocoa etc.

8. The portable cup lid of claim 1, wherein the cup lid is adapted for a reversible association with a container or glass or cup or vessel.

9. The portable cup lid of claim 1, wherein the cup lid is made of resistant thermo plastic or non plastic materials.

10. The portable cup lid of claim 1, wherein the cup lid is disposable.

11. A portable cup lid, comprising of:
an annular cover may be engaged with container or glass or cup or vessel;
an ingesting receptacle with a conduit for drinking or sipping; and
a infuser basket disposed within the said annular cover;
wherein: the said infuser basket, is D-shaped, placed to the far end of the ingesting receptacle and away from the centre, that restricts the fluid contact when the container or glass or cup or vessel is tilted up to a maximum of 90 degrees towards the ingestion receptacle, with the fluid level in the container or glass or cup or vessel around half the maximum length; and the said D shaped infuser extends downwardly to the fluid surface to immerse the infusible materials and facilitate infusion.

12. The portable cup lid of claim 11, wherein D-shaped infuser basket having uniform perforations on the surfaces.

13. The portable cup lid of claim 11, wherein D-shaped infuser basket is allowed for introduction of loose or bagged infusible material.

14. The portable cup lid of claim 11, wherein the infusible material further comprise of tea, soups, herbal drinks, coffee, cocoa etc.

15. An integrated cup lid assembly, comprising of:
an annular cover engaged with container or glass or cup or vessel;
an ingesting receptacle with a conduit for drinking or sipping;
a infuser basket also called as strainer is disposed within the said annular cover;
and a container or glass or cup or vessel acting as a fluid reservoir.

16. An integrated cup lid assembly 15, wherein infuser basket is D-shaped having uniform perforations on the surfaces, lockable air tight cover with live hinge lift tab of D-shape and at least one overflowing holes at upper end.

17. An integrated cup lid assembly 15, wherein D-shaped infuser basket is allowed for introduction of loose or bagged infusible material.

18. An integrated cup lid assembly 15, wherein the infusible material further comprise of tea, soups, herbal drinks, coffee, cocoa etc.

19. An integrated cup lid of claim 15, wherein the cup lid is disposable.

20. An integrated cup lid of claim 15, wherein the cup lid is non-disposable.
